(19) United States
(12) Patent Application Publication
(10) Pub. No.: US 2012/0261056 A1
(43) Pub. Date: Oct. 18, 2012

(54) METHOD FOR ASSEMBLY OF INSULATION GLASS BLANKS

(75) Inventor: Leopold MADER, Neuhofen/Ybbs (AT)

(73) Assignee: INOVA LISEC TECHNOLOGIEZENTRUM GMBH, Seitenstetten (AT)

(21) Appl. No.: 13/364,747

(22) Filed: Feb. 2, 2012

(30) Foreign Application Priority Data
Apr. 18, 2011 (AT) A 543/2011

(51) Int. Cl. C03C 27/10

(52) U.S. Cl. 156/109

(57) ABSTRACT

To implement assembly of insulation glass blanks (6), in which the spacer (3) is coated on both sides with a bead (4) that consists of a heat-activatable adhesive, the adhesive is heated to its activation temperature in such a way that the spacer (3) is heated by applying voltage in the way of an electrical resistance heating.

The invention relates to a method for assembling insulation glass blanks, in which method the glass panels are connected to the spacer by a heat-activatable adhesive, in particular a hot-melt adhesive.

Up to now, an assembly of insulation glass blanks of the above-mentioned type had been employed in such a way that the packet that was composed of two or three panes with spacer(s) inserted in-between was introduced into a heating press, and after the glass panels and adhesive were heated to the activation temperature thereof, the packet was pressed together to bring the glass panels to rest on the heated adhesive.

This mode of operation has the drawback that in the interior space of the insulation glass, negative pressure develops during cooling, which has the result of a concave bending of the glass panels.

Another drawback consists in that in this mode of operation, a filling of the insulation glass with a gas that is different from air is not possible.

The object of the invention is to make available a method of the above-mentioned type with which insulation glass of the above-mentioned type can be easily produced.

This object is achieved according to the invention with a method that has the features of Claim 1.

Preferred and advantageous configurations of the invention are subjects of the subclaims.

Since, with the method according to the invention, not the entire pane packet but rather only the spacer is heated by being introduced into a heated press, the above-mentioned problems of known operating procedures do not occur.

Other details and features of the method according to the invention follow from the description below based on the schematic drawings. Here:

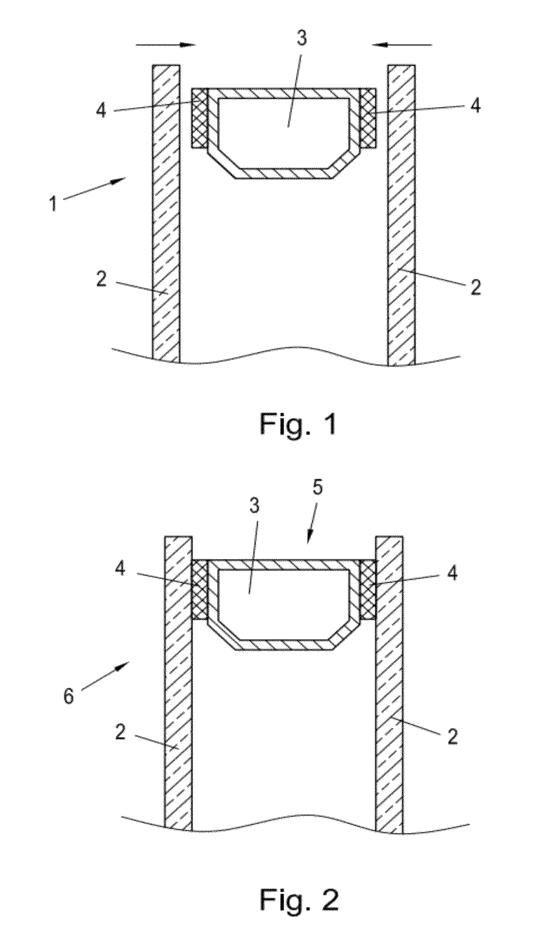

FIG. 1 shows a packet that was composed of glass panes and spacers before the assembly of an insulation glass blank, and

FIG. 2 shows an insulation glass blank after the assembly according to the method according to the invention,

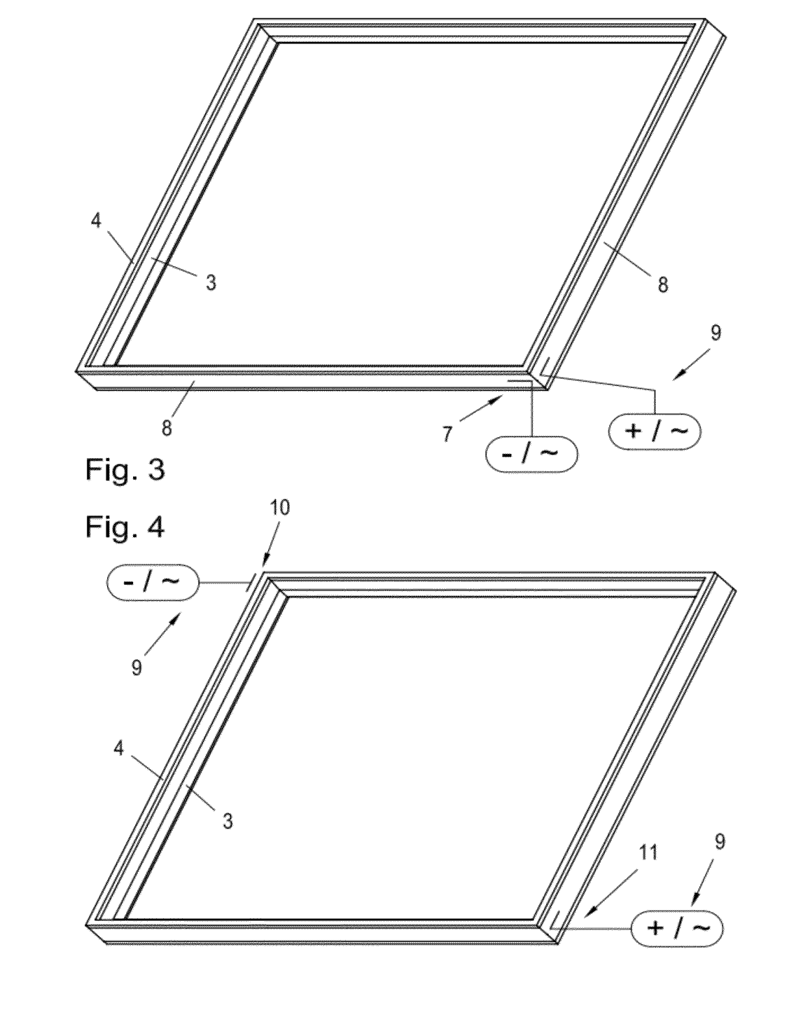

FIG. 3 shows a first variant, such as voltage that can be applied to a spacer, and

FIG. 4 shows a second variant, such as voltage that can be applied to a spacer.

A packet 1 for the production of an insulation glass blank consists of two glass panes 2 (glass panels) and a spacer 3 inserted in-between. Both lateral surfaces of the spacer 3, which are turned toward the glass panes 2, are coated with a layer 4 (bead) that consists of heat-activatable adhesive, which is, e.g., a hot-melt adhesive. This packet is introduced into a press for the assembly of insulation glass blanks 1. At the same time, this press can be a press in which the insulation glass blank is filled with a gas that is different from air (e.g., a noble gas).

To heat the spacer 3 (that consists of electric-current-conducting metal or at least partially consists of current-conducting metal) and thus also the adhesive beads 4 applied thereto in order to activate the latter by heat, the latter is connected to a current source so that the latter is directly heated by the current that flows through the spacer 3 because of the electrical resistance of the material of the spacer 3 (the latter is an electrically-conducting material). The heating is continued until the adhesive beads 4 have reached the temperature that is necessary for activating the adhesive.

Then, optionally after the filling of a gas that is different from air into the space in the press, the glass panes 2 are pressed onto the lateral surfaces of the spacer 3 or the adhesive beads 4 that consist of adhesive, provided there, and after the adhesive of the insulation glass blank is cooled, said panes are removed from the press.

The insulation glass blank 6 is then, as is common for the production of insulation glass, conveyed to a sealing station in which the edge seam 5 of the insulation glass blank that is open toward the outside is filled in with a sealing compound, for example a polysulfide-based compound.

In the embodiment shown in FIG. 3, the spacer 3 is bent to a frame that is still open at one corner 7, or is connected there by a non-current-conducting (electrically insulating) corner connector (for example, a corner angle that consists of plastic). In the area of the corner 7, in which the two legs 8 of the (frame-shaped) spacer 3 that lead to this corner 7 are not connected in an electrically-conductive manner, i.e., are electrically insulated from one another, the spacer 3, as explained above, is connected to a current source 9 (direct current or alternating current) so that the spacer frame can be heated to activate the adhesive beads 4 that consist of heat-activatable adhesive (hot-melt) that are applied thereon.

In the variant shown in FIG. 4, the spacer 3 is a frame that is connected to all four corners, whereby the corners, for example, could have been produced by integral bending of a spacer sectional strip. In this case, voltage is applied to corners 10, 11 that are opposite to one another (diagonally opposite corners), so that the spacer 3 is heated by the current that flows through it depending on the type of resistance heating in order to activate the adhesive of the adhesive beads 4 that are applied thereto.

The heat-activatable adhesives that can be used within the scope of this invention are known under the designation hot-melt in the insulation glass sector. In this case, this is typically a thermoplastic sealant that can be processed at high temperatures (150 to 180° C.).

In this case, butyl-based hot-melt adhesives, such as solvent-free hot-melt adhesives based on butyl rubber, are also taken into consideration.

In summary, one embodiment of the invention can be described as follows:

To implement assembly of insulation glass blanks 6, in which the spacer 3 is coated on both sides with a bead 4 that consists of a heat-activatable adhesive, the adhesive is heated to its activation temperature in such a way that the spacer 3 is heated by applying voltage in the way of an electrical resistance heating.

1. Method for assembling insulation glass blanks, in which the glass panels are connected to a spacer by a heat-activatable adhesive, characterized in that the heat-activatable adhesive is heated to the activation temperature by the spacer being heated.

2. Method according to claim 1, wherein the spacer is heated by applying an electrical voltage in the way of resistance heating.

3. Method according to claim 2, wherein the electrical voltage is applied on two corners of the spacer that are opposite to one another.

4. Method according to claim 2, wherein the voltage is applied to the ends of two legs of the spacer, which are electrically insulated from one another.

5. Method according to claim 4, wherein the ends of the leg, to which voltage is applied, are arranged in the area of one corner of the spacer.

6. Method according to claim 1, wherein the heat-activatable adhesive is an adhesive based on a thermoplast, butyl rubber, or solvent-free hot-melt.
